(19) United States
(12) Patent Application Publication
(10) Pub. No.: US 2024/0428754 A1
(43) Pub. Date: Dec. 26, 2024

(54) Interchangeable and modular electric guitar apparatus

(71) Applicant: Ronald Marlin Denoo, Fort Wayne, IN (US)

(72) Inventor: Ronald Marlin Denoo, Fort Wayne, IN (US)

(21) Appl. No.: 18/744,655

(22) Filed: Jun. 16, 2024

Related U.S. Application Data
(60) Provisional application No. 63/523,031, filed on Jun. 24, 2023.

(51) Int. Cl. G10D 1/00; G10D 3/00

(52) U.S. Cl. CPC G10D 1/00; G10D 3/00

(57) ABSTRACT

The present invention relates to an advancement in electric guitar assemblies wherein the easy-to-remove pickguard and the headstock logo are disclosed. The assembly involves magnetic properties facilitating users to customize the guitar body, wherein no special tools are required to fulfill the purpose. It is a further objective of the present invention to provide an innovative design that can be managed by the player without the use of sophisticated tools and without removing the strings from the guitar.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

This application is generally related to musical instruments, and in particular, to a modular assembly wherein the pickguard and the headstock logo are held in place by magnets so they can be easily swapped by the player without the use of tools.

### Description of the Related Art

A stringed musical instrument, such as a guitar, transmits sounds when the musical instrument's strings are plucked, strummed or otherwise made to vibrate. Different styles of music, such as rock and country, may utilize different techniques in playing and can necessitate musical instruments having a variety of decorative configurations. Furthermore, even within a particular style of music, different performers will have different styles of playing and individual performers may desire a selection of instruments having various decorative configurations. Generally, stringed musical instruments soundboards protectors and headstock decorations are individually screwed glued or otherwise permanently or semi-permanently attached during the production process. As such, anyone desiring the flexibility of different soundboard protector and headstock decoration configurations is generally forced to purchase a separate instrument for each soundboard and neck configuration desired.

One known musical instrument with an interchangeable soundboard and an interchangeable neck is disclosed in U.S. Pat. No. 5,347,904, issued on Sep. 20, 1994 to Barry G. Lawrence. However, Lawrence does not suggest the use of an interchangeable soundboard protectors or headstock decorations in accordance with the claimed invention.

Other prior art stringed instruments or constructional techniques are shown or described in U.S. Design Pat. No. 209,707, issued on Dec. 26, 1967 to Charles A. Gauvin; U.S. Design Pat. No. 272,747, issued on Feb. 21, 1984 to Ernest Nussbaum; U.S. Design Pat. No. 290,130, issued on Jun. 2, 1937 to Ned Steinberger; U.S. Design Pat. No. 324,693, issued on Mar. 17, 1992 to Floyd D. Rose; U.S. Pat. No. 3,911,777, issued on Oct. 14, 1975 to Stanley E. Rendell; U.S. Pat. No. 3,915,049, issued on Oct. 28, 1975 to Clifford T. Bean; U.S. Pat. No. 4,132,143, issued on Jan. 2, 1979 to Thomas D. Stone; U.S. Pat. No. 4,763,555, issued on Aug. 16, 1988 to Kiyoshi Minakuchi et al.; U.S. Pat. No. 4,768,415, issued on Sep. 6, 1988 to Charles A. Gresset, Jr., et al.; U.S. Pat. No. 5,025,696, issued on Jun. 25, 1991 to John M. Brown; U.S. Pat. No. 5,029,511, issued on Jul. 9, 1991 to Kevin Rosendahl; U.S. Pat. No. 5,325,757, issued on Jul. 5, 1994 to Serban Ghenea; U.S. Pat. No. 5,438,158, issued on Aug. 1, 1995 to John T. Riboloff; German Patent Number 2,631,866, published on Jan. 20, 1977; and German Patent Number 3,416,581, published on Nov. 8, 1984. The goal of a particular invention is to provide a modular and swappable electric guitar assembly wherein. The pickguard and the headstock logo are held in place by only magnets so they can be easily swapped by the player without the use of tools.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve upon prior electric guitar devices and provide an enhanced design to perform the designated functionality.

Another object of the present invention is to provide an electric guitar wherein the pickguard and the headstock logo are held in place by magnets and they can be easily swapped.

It is a further objective of the present invention to provide an innovative design that can be managed by the player without the use of sophisticated tools and without removing the strings from the guitar

It is also the object of the invention to provide an assembly that allows easy customization by changing the color, shape, material, or decorative pattern of the pickguard or headstock logo.

It is moreover the objective of the invention to provide a metal layer on the pickguard that can enhance noise shielding in the guitar

It is a further objective of the invention to provide a device that is developed from high-quality materials ensuring the long-term productivity of the device.

Thus, it is the objective to provide a new and improved form of electric guitar. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 shows the multiple perspective views of the proposed assembly.

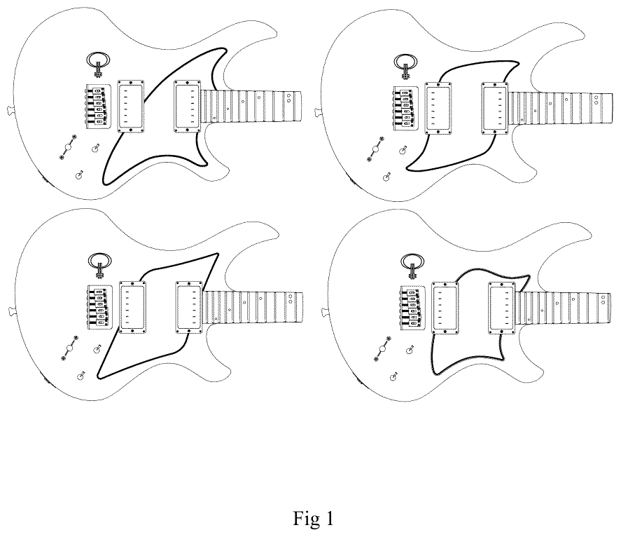

FIG. 2 shows the detailed configuration of the proposed assembly.

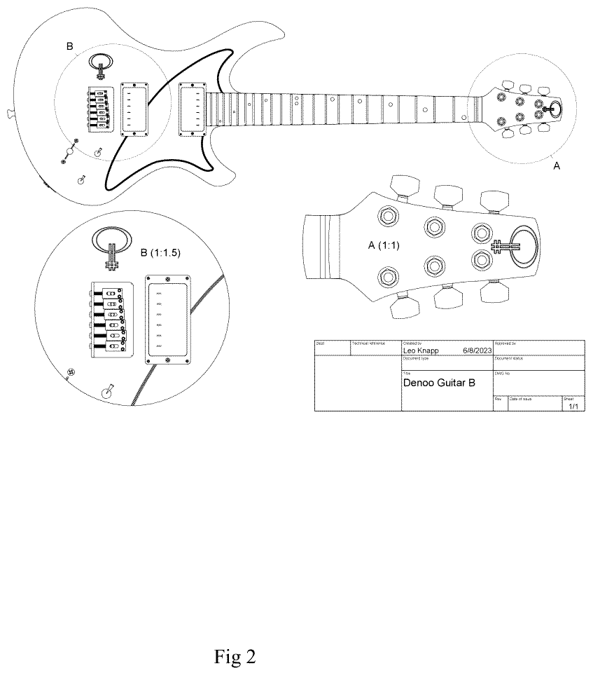

FIG. 3 shows the pickguards of the proposed assembly.

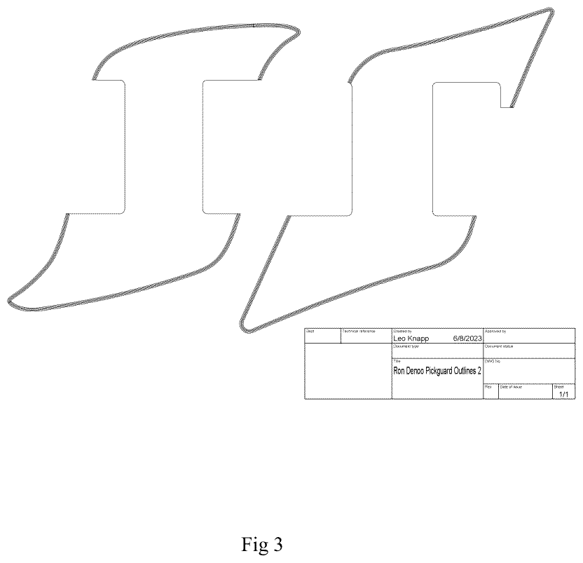

FIG. 4 shows another view of pickguards of the proposed assembly.

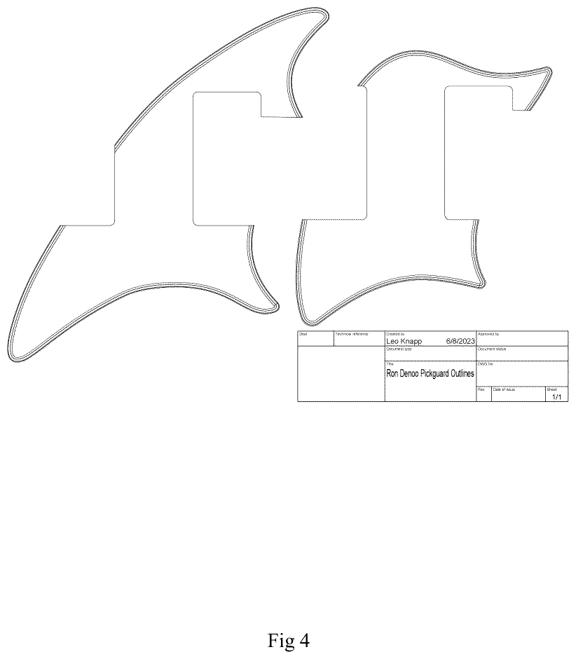

Skilled artisans will appreciate those elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The current invention as per its preferred embodiments presents a musical instrument wherein a skeletal frame system with an interchangeable pickguard and the headstock logo is disclosed.

The assembly as per its preferred embodiments aims to provide improved elements and arrangements thereof in a stringed musical instrument skeletal frame system for the purposes described which is inexpensive, dependable and fully effective in accomplishing its intended purposes.

The configuration of the assembly includes components that are much the same as are found in most conventional guitars, including a soundboard and a neck assembly. The soundboard has a front side, and a rear side, and includes a longitudinal slot on the front side, for engagement with the neck assembly. The soundboard may be either a hollow body or a solid body. The neck assembly includes a headstock and a fingerboard. The headstock is located at the top of the neck assembly and includes a plurality of tuning peg screws as well as a logo or other decorative element. Along the length of the neck assembly, a fingerboard is affixed or it may be merely an exposed surface of a single component, an integral neck assembly structure. The pickguard and the headstock logo are placed by magnets allowing them to be removed easily by the user without use of any sophisticated tool. It also allows ease in customization as per the user's requirements.

The assembly as per its further embodiments also includes pick guards, wherein the pickguard consists of one or more layers of materials. The first layer i.e., in contact with the body is developed from strong and magnetic materials like steel or stainless steel. The second layer is a decorative layer, that can be developed from colored plastic or wood.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A modular and swappable electric guitar assembly comprising:
at least one string instrument neck assembly with headstock;
and a modular body assembly with a protective plate (pickguard);
The electric guitar as per claim 1, wherein the pickguards and headstock are kept in place by a magnet.

2. The electric guitar as per claim 1, wherein the pickguard is enclosed by the pickups to keep it from moving in X-Y place while the magnets keep it secured in Z direction.

3. The electric guitar as per claim 1, wherein the headstock logo is inset into the head to keep it in place.

4. The electric guitar as per claim 1, wherein the metal layer on the pickguard enhances noise shielding in the guitar.
